(19) United States
(12) Patent Application Publication
(10) Pub. No.: US 2025/0027621 A1
(43) Pub. Date: Jan. 23, 2025

(54) TRANSPORTABLE SOLAR UNITS FOR LIGHTING

(71) Applicant: Rodrigo Marcelo VAN WEEZEL UTRERAS, San Pedro de la Paz (CL)

(72) Inventor: Rodrigo Marcelo VAN WEEZEL UTRERAS, San Pedro de la Paz (CL)

(21) Appl. No.: 18/377,094

(22) Filed: Oct. 5, 2023

(30) Foreign Application Priority Data
Jul. 17, 2023 (CL) 202302078

(51) Int. Cl. F21L 14/04; B60P 3/18; F21L 4/08; F21V 21/38; H02S 10/40; H05B 47/19

(52) U.S. Cl. CPC F21L 14/04; B60P 3/18; F21L 4/08; F21V 21/38; H02S 10/40; H05B 47/19; F21W 2131/1005

(57) ABSTRACT

A transportable solar lighting unit with a cover of solar panels and a tower with lighting spotlights to quickly illuminate all types of operations and/or tasks in places with a lack of conventional electrical grid and a need for energy and lighting sources in places that are difficult to access.

### TECHNICAL FIELD

This application refers to the technical field of Transportable Solar Units for Lighting.

### BACKGROUND OF THE INVENTION

These Transportable Solar Lighting Units arise to provide a quick lighting solution for all types of operations and/or tasks in places that do not have access to traditional cable lighting, in such a way as to facilitate field work. They are a reliable and immediately operational alternative in areas that do not have a conventional electrical grid. By simply extending its group of lighting spotlights with its Telescopic tower, it is ready to be operated and can be installed in any place accessible by vehicle. Its panels integrated into the SIP panel box that are part of the body of the tow truck, are always charging batteries, without the need to move or deploy the solar panels and their strength and excellent quality characteristics allow them to always be outdoors (without need to cover or store them).

### BRIEF DESCRIPTION OF THE INVENTION

The invention aims to solve the technical and operational problems related to: lack of conventional electrical grid and need for energy and lighting sources in places that are difficult to access. For this reason, this publication provides details of a Transportable Solar Lighting Unit that is convenient for its immediate start-up, easy inspection of all its components, easy maintenance, short recovery period of the investment and non-polluting to the environment.

The Transportable Solar Units for Lighting are composed of:
Two or more wheels with a torsion axle
Chassis made of galvanized steel or other suitable materials.
Structural volumetric body manufactured with SIP panels or other materials appropriate to the user's requirements, with a projecting door for maintenance and programming of the electro-electronic components.
Bank of deep cycle GEL batteries or other latest generation batteries on the market, from four to eight units or other equivalent lithium batteries.
Electrical metal box with: MPPT Controller, automatic protection switches and timer.
Two or more solar panels bolted to the panel body.
Our INGESUM Telescopic Tower operated with a winch or winch.
A spotlight holder frame.
In some models it has an inverter to charge different electrical devices.

The Transportable Solar Units for Lighting, according to this publication, due to their characteristics, are easy to inspect and maintain parts, assemblies, devices and others. In addition, its design is to prevent dust and water from entering the interior of the main body.

The Transportable Solar Units for Lighting were designed with a fixed inclination of the Solar Panels that form an integral part of the body or box of SIP Panels, with an inclination that could vary between 0° to a maximum of 90° depending on the dimensions of each solar panel used. for its manufacturing and configuration of the box body, without changing its shape that characterizes it as a monolithic volume.

In Transportable Solar Units for Lighting, the solar panels deliver the energy generation to a controller, which in turn charges the batteries. When the spotlights are used, energy is delivered by the batteries to the Lighting bulbs.

Additional aspects and advantages of this publication will be given in the following detailed description.

### BRIEF DESCRIPTION OF THE FIGURES

FIG. 1 is a digital image as a diagram of a Transportable Solar Unit for Lighting; Main body (1) and Side door (2) are identified.

FIG. 2 is a digital image as a diagram of a Transportable Solar Unit for Lighting; The mast device (3), lighting device (4) and quick-type connectors (23) are identified.

FIG. 3 is a digital image as a diagram of a Transportable Solar Unit for Lighting; Trailing system (5), forklift support (27) are identified.

FIG. 4 is a digital image as a diagram of a Transportable Solar Unit for Lighting; The electrical panel (6) and battery bank (7) are identified.

FIG. 5 is a digital image as a diagram of a Transportable Solar Unit for Lighting; Solar modules (8), winch (25), lighting device pivoting system (26) and position of the fire extinguisher (22) are identified.

FIG. 6 is a digital image as a diagram of a Transportable Solar Unit for Lighting; The storage position of the stabilizer type support legs (9), storage of the hitch system (15) and position of the joint wedge system (24) are identified.

FIG. 7 is a digital image as a diagram of a Transportable Solar Unit for Lighting; storage of the dragging system (10) and pallet-type base for transporting (TSFV) (20) are identified.

FIG. 8 is a digital image as a diagram of a Transportable Solar Lighting Unit; Location and use of the lifting lugs (11) are identified.

FIG. 9 is a digital image as a diagram of a Transportable Solar Unit for Lighting; Mast device storage (3), lighting device storage (4) and wheel assembly storage (18) are identified.

FIG. 10 is a digital image as a diagram of a Transportable Solar Unit for Lighting; Rotating lighting device system (14) is identified.

FIG. 11 is a digital image as a diagram of a Transportable Solar Unit for Lighting; A location is identified to store three photovoltaic solar towers in a twenty-foot container (16), secure for transportation on lifting lugs (19).

FIG. 12 is a digital image as a diagram of a Transportable Solar Unit for Lighting; A location is identified to store seven photovoltaic solar towers in a forty-foot container (17).

FIG. 13 is a digital image as a diagram of a Transportable Solar Unit for Lighting; The location of the pair of switches and connectors is identified if there is an inverter to charge cell phones, computers or other larger volume electrical items (21).

FIG. 14 is a digital image as a diagram of a Transportable Solar Unit for Lighting; It is seen attached to the vehicle.

### DETAILED DESCRIPTION OF THE INVENTION

The models described below in relation to the attached figures are referential and are intended to explain this publication but should not be interpreted as a limitation of this publication.

The following publication provides examples of Ingesum spaTransportable Solar Lighting Units.

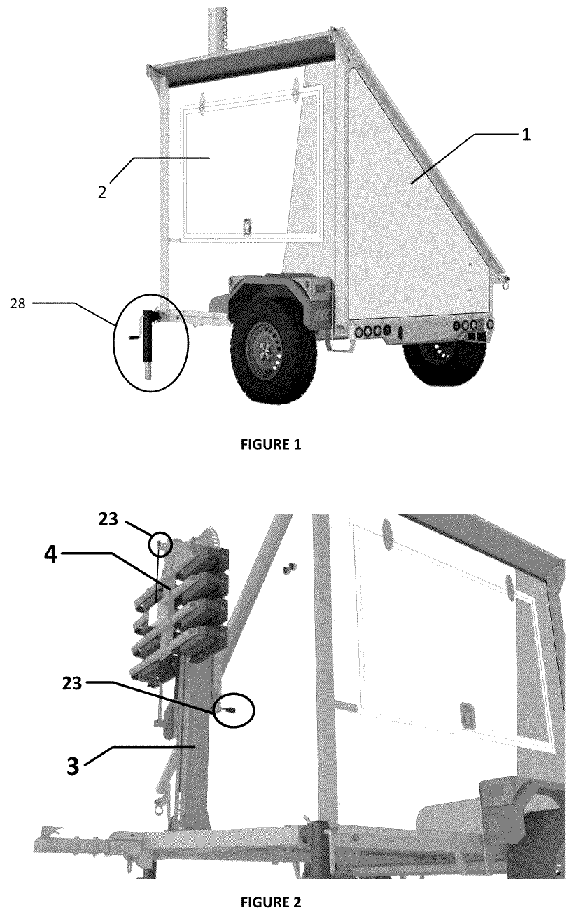

In FIG. 1 it is observed that the Transportable Solar Unit for Lighting is composed as an entire main body (1), therefore, we can see on its widest side the side door (2) which can be mobile or removable; In the mobile case it can be opened and closed from bottom to top in a pivoting manner; However, the Transportable Solar Lighting Unit of this publication facilitates the review and/or maintenance of parts, assemblies, devices. The ease of opening the side door (2) improves maintenance efficiency and can prevent dust, water and others. In addition, you can see the location of the legs or jacks that allow firmness to the transportable solar unit for lighting (FIGS. 1 and 5).

It should be noted that the manufacturing design of the main body structure (1) is not limited, for this reason, its main variation depends on the dimensions of the solar panels existing on the market, that is, its characteristic shape is maintained. The only thing that changes are its dimensions, both length, width and height and of course varying the angle of inclination of the solar panels, which should not exceed 90 degrees.

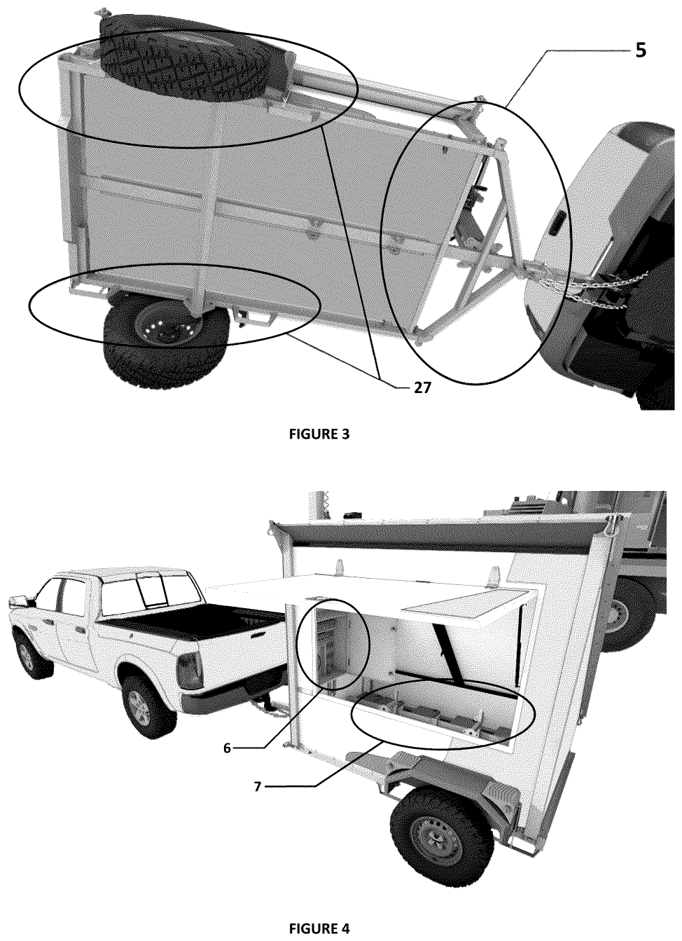

In FIGS. 2 and 3; The Transportable Solar Lighting Unit includes a mast device (3) whose height can be adjusted through a winch (25) to the user's needs, in this case it can be variable up to approximately seven meters. It should be noted that the winch (25) has an automatic brake system which, for safety reasons, the user can raise or lower the mast device (3) without compromising effort or concern that it may descend alone due to its own weight. Because the winch (25) is manually maneuvered during operation, it is protected by a metal box, which can prevent possible accidents for the user in the future.

In FIGS. 2 and 5; The lighting device (4) is made up of a set of lighting spotlights, each one is located adjusted on bolts in a support exclusively adapted to keep them fixed in place, this can vary in quantity between two to eight or as required by the user, in this way its consumption and lumens vary; but its operating principle does not change. The lighting device (4) is located at the top of the mast device (3), its function is to raise it to the desired height and illuminate the required area at the user's convenience; The lighting device (4) has a pivot type system (26) for safe transportation and remains in a locked position and downwards for either long or short transportation.

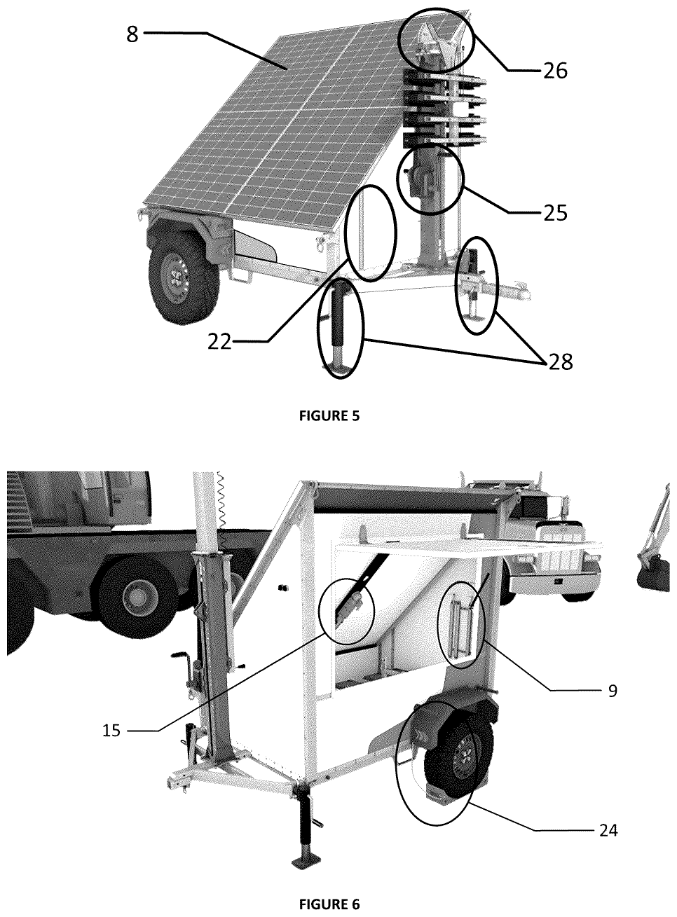

In FIGS. 3 and 6; The Transportable Solar Unit for lighting has a towing system (5) and can be fixed to the chassis of the main body (1) of FIG. 1, or removable for easy transportation purposes; Its attachment system (15) to the vehicle depends on the type of connector, whether ball type or ring type; it can also be fixed or removable with the attachment system (5); The hooking system (5) is a device that works as a coupling hand to hook and unhook the vehicle connector. It should be noted that when the drag system (5) is mobile, so is the hitch system (15), therefore, when the drag system (5) is fixed, so is the hitch system (15). It should be considered that the towing system (5) and the hooking system (15) together make up the towing lance of the transportable solar unit for lighting.

It should be noted that the Transportable Solar Unit for lighting also includes in the manufacturing design in the lower part of its chassis of the main body (1) of FIG. 1, a set of supports (27) to position the nails of the forklift, in this way it can be raised safely and easily moved from one place to another without the need to be hitched to the vehicle as seen in FIG. 3. Additionally in FIG. 5, we can see as an example the position of the solar modules (8) and the location where the fire extinguisher (22) could be positioned.

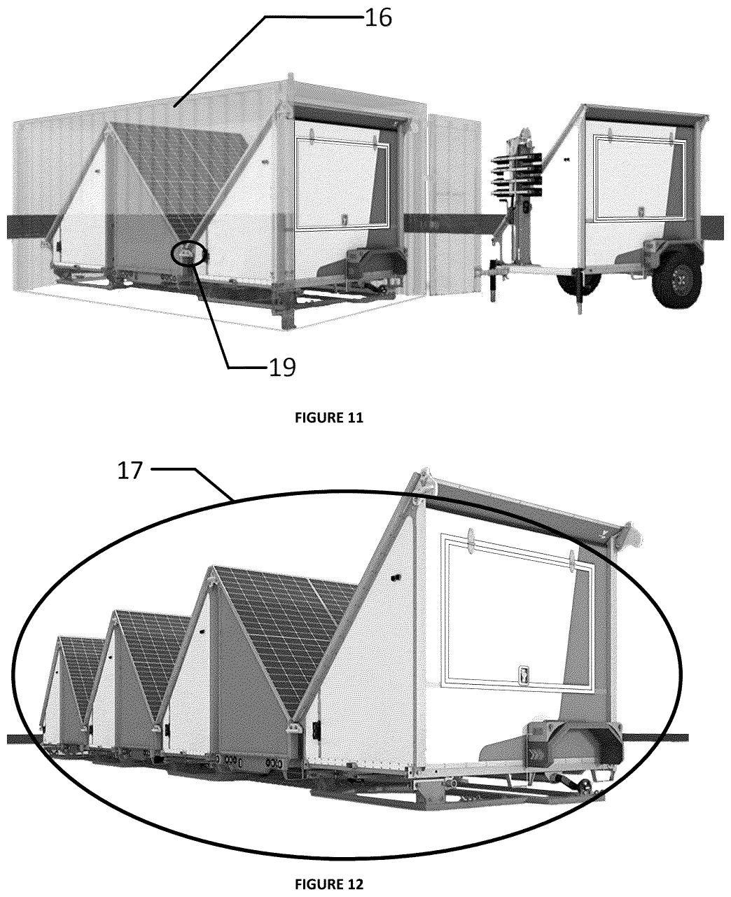

It should be noted, the advantage of the support set (27) is that it facilitates the maneuver to move the Transportable Solar Units for Lighting and to be stored in twenty- and forty-foot containers; Three photovoltaic solar towers are stored in a twenty-foot container (16). They are secured to each other through a system similar to a frange that is bolted to the lifting ears (19) of each Transportable Solar Unit for Lighting; According to the above, the same applies for a forty-foot container (17) (for example, as shown in FIGS. 11 and 12).

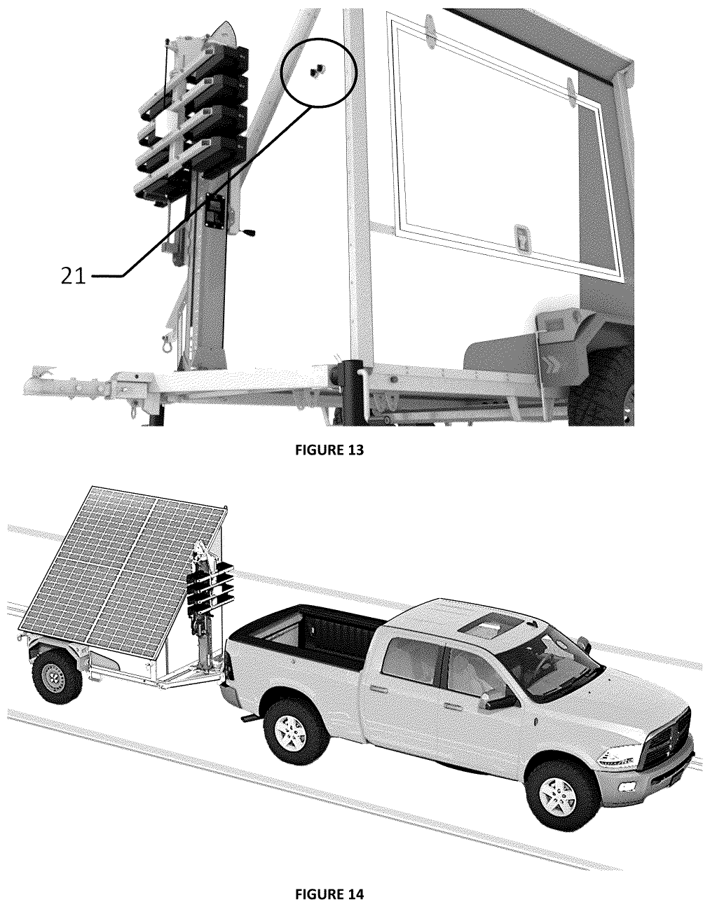

The Transportable Solar Units for Lighting are composed of: an electrical panel (6) and a battery bank (7), as an example shown in FIG. 4; The main task of the electrical panel (6) with its controller is to receive electrical energy from the solar modules (8) and adequately supply the energy to the battery bank (7), therefore, the battery bank (7) must supply the energy that the lighting device (4) needs to consume. It should be noted in FIG. 13, the system of light switches (21) can be seen, it turns on and off two groups of lighting spotlights, being two in two, three in three or four in four, in the case that they were four, six, eight lights or according to the quantity required by the user; In the case of two spotlights, a single light switch would suffice; Therefore, in some models of transportable solar units, they may include in the same area of the switches (21) a group of connectors or plugs for fast charging of electronic devices such as cell phones, notebooks, among others. In summary, the electrical panel (6), the battery bank (7) and through the switch system (21) can provide reliable electrical power to the lighting device (4) correctly.

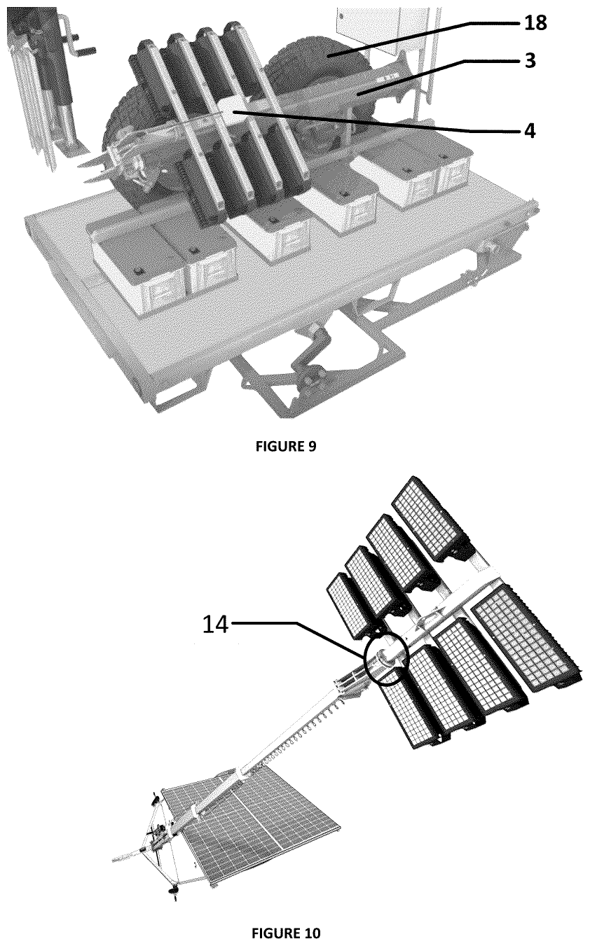

The Transportable Solar Units for Lighting, the lighting device (1), the mast device (3) and the set of wheels (18) in FIG. 9 we can see as an example the shape and position where they are stored, being as a whole the mast device (3) and the lighting device (1), the same before being uninstalled. Both must be disconnected from the quick connector system (23) to the drag system (10), facilitating the operation in a quick and safe manner. Near the side door (2) the set of wheels (18) is stored for transportation, thus making better use of space and operating comfort.

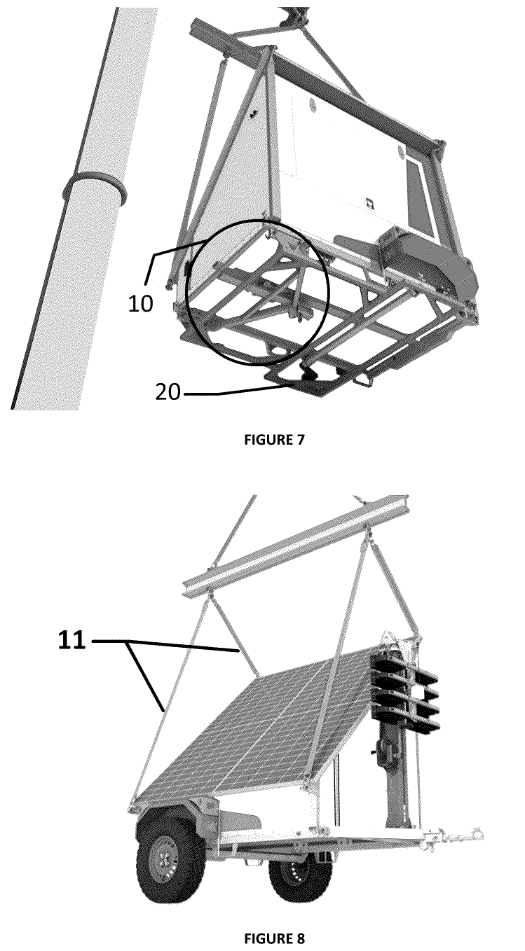

It should be noted that before subjecting the transportable Solar Lighting Unit to transfer or transport, the towing system (10) must be unhooked and stored in the lower part of the main body chassis (1), as indicated below. example in FIG. 7; Likewise, we can see a pallet-type metal base (20), its function is to reduce its height and facilitate its safer transportation by container or truck platform.

In FIG. 6, as an example we can see where the group of wedges (24) is stored, it is secured by means of a cable to prevent its loss and of course providing security during its transfer; You can also see the place where the support group or stabilizing legs (9) secured to the wall are stored, thus guaranteeing safe transportation; The stabilizing supports or legs (9) fulfill the function of maintaining its height in a static or parking position when the transportable solar lighting unit is not hooked to the vehicle.

In FIG. 8, as an example we can see the location of the lifting ears (11); In this way, the Solar Lighting Units have another alternative for transport or movement on site through a crane, being more useful if they are on very uneven terrain or even being positioned on a structure or terrain that is difficult to access by vehicle.

The lighting device (4) has a very favorable advantage for the user, since, for the ease of illuminating another area, for example, the back, it has a rotating system (14) capable of Gently rotate the degrees required from 0 to 360 degrees. As we can see as an example in FIG. 10.

In FIG. 14, we can see as an example a general view of the Solar and Lighting Unit, hooked to a vehicle.

In some models of Solar Lighting Units, they may include a real-time remote monitoring system, using the GSM network as a communication service. Its purpose is to observe and review its operating values. Additionally, they can include a geolocation system, being a great advantage to be able to know the location of the Solar Lighting Unit.

1. A transportable solar lighting unit with a cover of solar panels and a tower with lighting spotlights to quickly illuminate all types of operations and/or tasks in places with a lack of conventional electrical grid and a need for energy and lighting sources in places that are difficult to access, CHARACTERIZED because it comprises a main body (1) in the upper part of which the solar modules (8) are located, whose inclination varies between 0° to a maximum of 90°;
on its widest side there is a side door (2) inside which is located an electrical panel (6), a battery bank (7), a mast (3), a lighting device (4) and the assembly wheels (18);
the electrical panel (6) has a controller to receive electrical energy from the solar modules (8) and supply energy to the battery bank (7), which in turn supplies energy to the lighting devices (4) located in the mast assembly (3);
On the outside, the system of light switches (21) is located, which turns on and off two groups of lighting sources, two by two, three by three or four by four;
The support set (27) can be stored in twenty- and forty-foot containers.

2. The transportable solar lighting unit according to claim 1, CHARACTERIZED in that the main body (1) and the mast (3) must be disconnected from the quick connector system (23) and the towing system (10), to be stored inside the door (2).

3. The transportable solar lighting unit according to claim 1, CHARACTERIZED in that the lighting device (4) is composed of a set of lighting spotlights, each one located adjusted on bolts in a support exclusively adapted to keep them fixed in place. Instead, this can vary in quantity between two to eight or as required by the user;
The lighting device (4) is located at the top of the mast device (3), its lighting height is adjusted by a winch (25).

4. The transportable solar lighting unit according to claim 3, CHARACTERIZED in that the mast (3) whose height can be adjusted through a winch (25) up to approximately seven meters, which has an automatic brake system and protected by a metal box to be manually maneuvered during operation.

5. The transportable solar lighting unit according to claim 1, CHARACTERIZED because it comprises a towing system (10) that can be fixed or removable to the main body (1) for transport purposes and Its attachment system (15) to the vehicle depends on the type of connector, whether ball or ring type.

6. The transportable solar lighting unit according to claim 5, CHARACTERIZED because in the lower part of its main body chassis (1) a set of supports (27) to position the nails of the forklift, thus being able to raise it. safely and easily moved from one place to another without the need to hitch to the vehicle.

7. The transportable solar lighting unit according to claim 6, CHARACTERIZED because it also comprises unhooking the towing system (10) and storing it in the lower part of the main body chassis (1) or in the pallet-type metal base (20).

8. The transportable solar lighting unit according to claim 1, CHARACTERIZED because it also comprises lifting ears (11) as another alternative for transferring or moving the main body (1) during work through a crane.

9. The transportable solar lighting unit according to claim 3, CHARACTERIZED because the lighting device (4) has a rotation system (14) capable of rotating between 0° to 360°.

10. The transportable solar lighting unit according to claim 5, CHARACTERIZED because it also comprises a real-time remote monitoring system, using the GSM network as a communication service, to observe and review its operating values; also, a geolocation system to know the location of the Solar Lighting Unit.

11. A transportable lighting device with a cover of solar panels and a tower with lighting spotlights to quickly illuminate all types of operations and/or tasks in places with a lack of conventional electrical grid and a need for energy and lighting sources in places that are difficult to access, CHARACTERIZED because it includes:
a main body (1) in whose upper part the solar modules (8) are located, whose inclination varies between 0° to a maximum of 90° depending on the dimensions of each solar panel used and the configuration of the box body, without changing its shape that It is characterized by a monolithic volume, on its widest side there is a side door (2) inside which is located an electrical panel (6), a battery bank (7), a mast (3), a lighting device (1) and the wheel assembly (18);
the electrical panel (6) with a controller to receive electrical energy from the solar modules (8) and supply energy to the battery bank (7), which in turn supplies energy to the lighting devices (4) located in the mast assembly (3);
On the outside, the system of light switches (21) is located, which turns on and off two groups of lighting sources, two by two, three by three or four by four;
The support set (27) can be stored in twenty- and forty-foot containers.

12. The mobile solar lighting device according to claim 11, CHARACTERIZED in that the main body (1) and the mast (3) must be disconnected from the quick connector system (23) and the towing system (10), to be stored inside the door (2).

13. The mobile solar lighting device according to claim 11, CHARACTERIZED in that the lighting device (4) is composed of a set of lighting spotlights, each one is located adjusted on bolts in a support exclusively adapted to keep them fixed in place. Instead, this can vary in quantity between two to eight or as required by the user;
The lighting device (4) is located at the top of the mast device (3), its lighting height is adjusted by a winch (25).

14. The mobile solar lighting device according to claim 13, CHARACTERIZED in that the mast (3) whose height can be adjusted through a winch (25) up to approximately seven meters, which has an automatic brake system and protected by a metal box to be manually maneuvered during operation.

15. The mobile solar lighting device according to claim 11, CHARACTERIZED because it also comprises a towing system (10) that can be fixed or removable to the main body (1) for transport purposes and Its attachment system (15) to the vehicle depends on the type of connector, whether ball or ring type.

16. The mobile solar lighting device according to claim 15, CHARACTERIZED because in the lower part of its main body chassis (1) a set of supports (27) to position the nails of the forklift, thus being able to raise it. safely and easily moved from one place to another without the need to hitch to the vehicle.

17. The mobile solar lighting device according to claim 15, CHARACTERIZED because it also comprises unhooking the drag system (10) and storing it in the lower part of the chassis of the main body (1) or in the pallet-type metal base (20).

18. The mobile solar lighting device according to claim 11, CHARACTERIZED because it also comprises lifting ears (11) as another alternative for transferring or moving the main body (1) during work through a crane.

19. The mobile solar lighting device according to claim 13, CHARACTERIZED because the lighting device (4) has a rotation system (14) capable of rotating between 0° to 360°.

20. The mobile solar lighting device according to claim 11, CHARACTERIZED because it also comprises a real-time remote monitoring system, using the GSM network as a communication service, to observe and review its operating values; also, a geolocation system to know the location of the Solar Lighting Unit.

21. The mobile solar lighting device according to claim 11, CHARACTERIZED in that the set of supports (27) can be stored in twenty- and forty-foot containers, in a twenty-foot container (16) three photovoltaic solar towers are stored., they are secured together through a system similar to a frange that is bolted to the lifting ears (19) of each transportable device, the same applies to a forty-foot container (17).
